(19) United States
(12) Patent Application Publication
(10) Pub. No.: US 2023/0045513 A1
(43) Pub. Date: Feb. 9, 2023

(54) CHAIN DRIVE OIL SEPARATOR

(71) Applicant: MAGNA INTERNATIONAL INC., Aurora (CA)

(72) Inventors: Manfred EICHINGER, Graz (AT); Alexander KLAR, Haselsdorf-Tobelbad (AT); Matthias KOHLHAUSER, Fernitz (AT)

(21) Appl. No.: 17/792,782

(22) PCT Filed: Jan. 14, 2021
(86) PCT No.: PCT/CA2021/050031

§ 371 Date: Jul. 14, 2022

Related U.S. Application Data
(60) Provisional application No. 62/960,871, filed on Jan. 14, 2020.

(51) Int. Cl. F16H 57/05; F16H 7/18; F16N 7/36; F01M 9/10

(52) U.S. Cl. CPC F16H 57/05; F16H 7/18; F16N 7/36; F01M 9/108

(57) ABSTRACT

A chain drive mechanism includes a chain extending around a drive sprocket and a driven sprocket for transmitting torque therebetween. The chain drive mechanism also includes a snubber including one or more guide shoes, each having an engagement surface that contacts a side of the chain between the drive sprocket and the driven sprocket. The engagement surface of the guide shoe defines a recess with an opening therein, with the recess configured to convey lubricant fluid, such as oil, from the chain and through the opening by motion of the chain along the engagement surface. The recess has a wedge shape including two side walls converging toward the opening, and a floor that slopes downwardly away from the engagement surface and toward the opening. The snubber includes one or more guide shoes that are inside, outside, or some combination of inside and outside of the chain.

### CROSS-REFERENCE TO RELATED APPLICATIONS

This PCT International Patent application claims the benefit of U.S. Provisional Patent Application Ser. No. 62/960,871 filed on Jan. 14, 2020, and titled “Chain Drive Oil Separator”, the entire disclosure of which is hereby incorporated by reference.

### BACKGROUND

Chain-driven units may use a chain to convey lubricants, such as oil. In some conventional systems, oil is picked-up by a rotating chain from an oil reservoir at the bottom of the unit. At appropriate speeds, oil may be ejected from the chain at the highest point in the unit and captured by an oil tank. Pipes may supply oil from this oil tank to surrounding components, for example, by using a gravity feed.

Such chain-driven oil circulation devices may employ a chain that exists in a machine for other purposes, such as for driving a pump, a camshaft, or a driven shaft in a transmission. However, such chain-driven oil circulation schemes may have several drawbacks. For example, the oil reservoir is only filled when oil is flung outwardly from the rotating chain, which requires adequate rotational speeds of the chain in order to work properly. At lower rotational speeds, the surrounding components may receive an inadequate supply of oil.

### SUMMARY

A guide shoe for a chain drive mechanism is provided in some embodiments of the present disclosure. The guide shoe comprises an engagement surface configured to contact a chain and a conduit configured to convey lubricant fluid away from the engagement surface. The engagement surface of the guide shoe defines a recess, the recess configured to convey the lubricant fluid from the chain into the conduit by motion of the chain along the engagement surface of the guide shoe.

A chain drive mechanism is provided in some embodiments of the present disclosure. The chain drive mechanism comprises a chain extending around a drive sprocket and a driven sprocket for transmitting torque therebetween. The chain drive mechanism also comprises a snubber including a guide shoe having an engagement surface contacting a side of the chain between the drive sprocket and the driven sprocket. The chain drive mechanism also includes a conduit configured to convey lubricant fluid away from the engagement surface. The engagement surface of the guide shoe defines a recess with an opening therein, and the recess is configured to convey lubricant fluid from the chain and through the conduit by motion of the chain along the engagement surface of the guide shoe.

### BRIEF DESCRIPTION OF THE DRAWINGS

Further details, features and advantages of designs of the invention result from the following description of embodiment examples in reference to the associated drawings.

FIG. 1 shows a chain drive mechanism in accordance with some embodiments of the present disclosure;

FIG. 2A shows a perspective view of a guide shoe in accordance with some embodiments of the present disclosure; and

FIG. 2B shows another perspective view of the guide shoe of FIG. 2A.

### DETAILED DESCRIPTION

Referring to the drawings, the present invention will be described in detail in view of following embodiments. Example embodiments of a chain drive mechanism are provided.

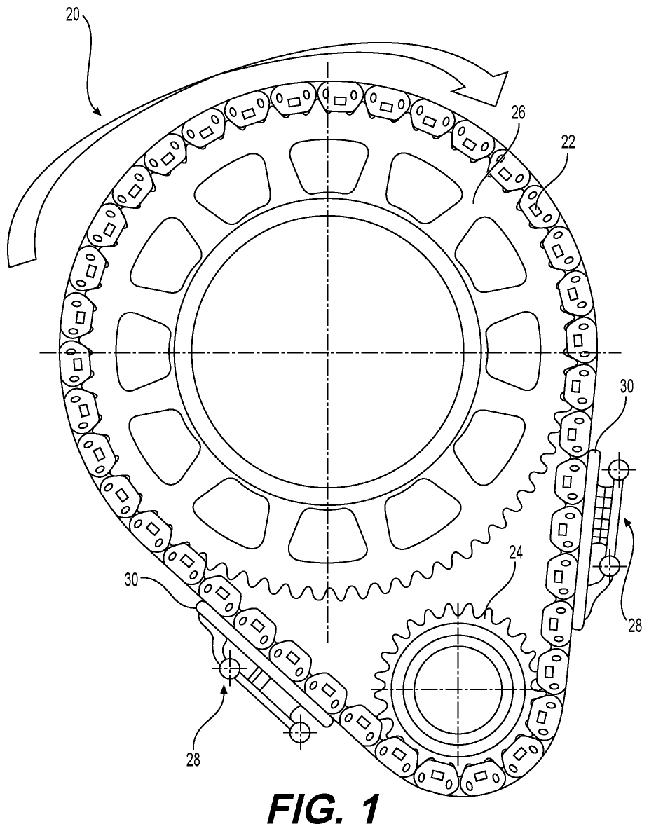

FIG. 1 shows a chain drive mechanism 20 in accordance with some embodiments of the present disclosure. The chain drive mechanism 20 includes a chain 22 extending around a drive sprocket 24 and a driven sprocket 26 for transmitting torque therebetween. The chain drive mechanism 20 also includes a snubber 28 that contacts the chain 22. The snubber 28 may be configured to reduce noise and/or vibration in the chain 22 as the chain 22 is turned. Additionally or alternatively, the snubber 28 may be configured to provide tension on the chain 22.

The snubber 28 includes one or more guide shoes 30, with each of the guide shoes 30 having an engagement surface 32 that contacts a side of the chain 22 between the drive sprocket 24 and the driven sprocket 26. In some embodiment, and as shown in FIG. 1, the snubber 28 includes two guide shoes 30, although the snubber 28 may include any number of guide shoes 30. The guide shoes 30 of the present disclosure may be variations of guide shoes already used in existing or conventional chain drive mechanisms. Alternatively or additionally, the guide shoes 30 of the present disclosure may be provided as additional parts that are not present in the existing chain drive mechanism.

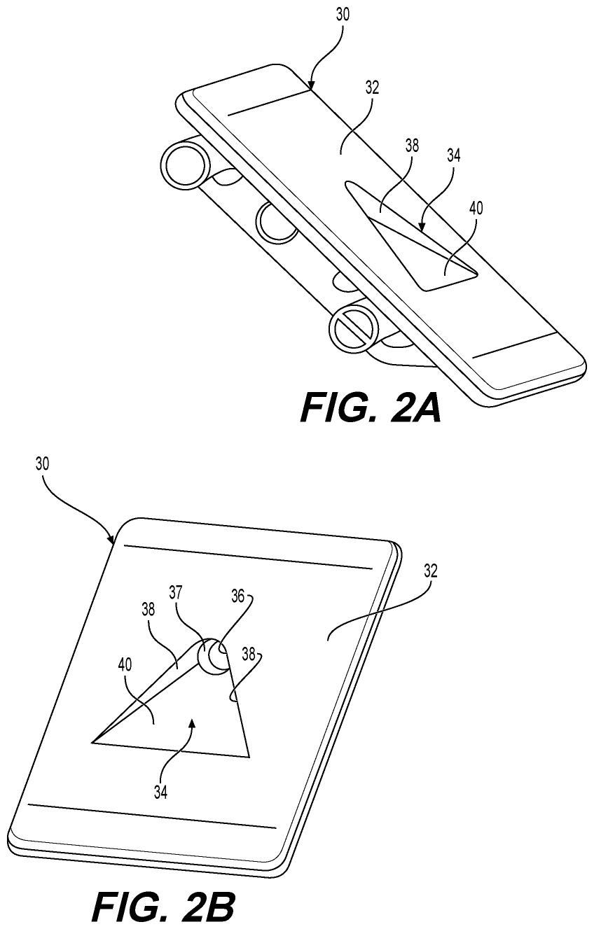

FIGS. 2A-2B show two different perspective views of a guide shoe 30 in accordance with some embodiments of the present disclosure. The engagement surface 32 of the guide shoe 30 defines a recess 34 with an opening 36 therein. A conduit 37 is in fluid communication with the opening 36 and configured to convey lubricant fluid away from the engagement surface 32. For example, the conduit 37 may include a bore or a tube extending through the guide shoe 30 to convey the lubricant fluid, such as oil from the chain 22, away from the engagement surface 32. The recess 34 is configured to convey the lubricant fluid from the chain 22 through the opening 36 and into the conduit 37 by motion of the chain 22 along the engagement surface of the guide shoe 30. opening 36 is in fluid communication with the conduit 37.

In some embodiments, the recess 34 has a wedge shape including two side walls 38 converging toward the opening 36. In some embodiments, each of the two side walls 38 follows a straight line in the engagement surface 32 of the guide shoe 30. Either or both of the side walls 38 may have other shapes, such as a continuous or non-continuous curve. The shape and/or size of the recess 34, the opening 36, and/or the conduit 37 may be selected to direct a predetermined amount of the lubricant fluid away from the engagement surface 32 and through the conduit 37. For example, the shape and size of the recess 34 may be selected to provide a specified flow rate of the lubricant fluid as the chain 22 is driven at a given speed or through a given range of speeds.

In some embodiments, the recess 34 includes a floor 40 that slopes downwardly away from the engagement surface 32 and toward the opening 36. The floor 40 may extend between the two side walls 38. The floor 40 may be a straight ramp into the guide shoe 30. Alternatively, the floor 40 may have a curve or an irregular shape, such as one or more steps or other features that may help to direct the fluid into the opening 36.

In some embodiments, the engagement surface 32 defines a flat plane around the recess 34. Alternatively, the engagement surface 32 may define another shape, such as a convex or a concave shape.

In some embodiments, the snubber 28 includes a biasing device (not shown in the FIGS.), such as a spring or a hydraulic cylinder, that is configured to bias the engagement surface 32 of the guide shoe 30 into contact with the chain 22.

In some embodiments, and as shown in FIG. 1, at least one of the guide shoes 30 is disposed outside of the chain 22. In some embodiments, at least one of the guide shoes 30 is disposed inside of the chain 22 with the chain surrounding the guide shoe 30. In some embodiments, the chain 22 may be sandwiched between two guide shoes 30, with one of the guide shoes 30 outside of the chain 22 and with another one of the guide shoes 30 disposed inside of the chain 22.

In some embodiments, the snubber 28 includes two or more guide shoes 30 that are each disposed inside of the chain 22, with the chain 22 surrounding the two or more guide shoes 30. Alternatively or additionally, the snubber 28 may include two or more guide shoes 30 that are each disposed outside of the chain 22.

The present disclosure also provides a method of conveying a lubricant fluid, such as oil, in a chain drive mechanism 20 by causing the oil to be directed from the chain 22 through a recess 34 in an engagement surface 32 of a guide shoe 30, and through an opening 36 by motion of the chain 22 along the engagement surface 32 of the guide shoe 30.

The specially designed slide shoe 30 presented herein is intended to serve as an alternative or additional option for collecting oil. Due to the special shape of the recess 34, which may be integrated into a conventional guide shoe 30 or sliding shoe 30, oil can be wiped off and collected before spinning. The oil collected can be transported to surrounding components by means of an opening 36 or hole, and any necessary lines in fluid communication with the opening 36. This means that components (e.g., bearings) can also be supplied with oil that cannot be supplied by conventional oil tanks or the associated lines due to complex geometries and installation options. Thanks to the special shape of the recess 34, which may be incorporated in a conventional sliding shoe 30, oil can be stripped from the chain 22 and collected before it is ejected and transported to surrounding components by means of lines. This works even at very low speeds, which is not the case with conventional solutions and can lead to insufficient lubrication.

The chain drive oiling system of the present disclosure provides several advantages over conventional systems. It provides for inexpensive lubricant transport without additional energy input. It may provide a more consistent and steady stream of lubricant to components, especially when the chain 22 is turning at relatively low speeds. It may also be less reliant upon gravity to feed oil from a reservoir to the components, and thus provide for improved operation in different orientations and/or in extreme duty conditions, such as under high acceleration and/or lateral loads.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A guide shoe for a chain drive mechanism, said guide shoe comprising:
an engagement surface configured to contact a chain;
a conduit configured to convey lubricant fluid away from the engagement surface; and
the engagement surface of the guide shoe defining a recess, the recess configured to convey the lubricant fluid from the chain into the conduit by motion of the chain along the engagement surface of the guide shoe, and wherein the recess includes a floor that slopes downwardly away from the engagement surface and toward the conduit.

2. The guide shoe of claim 1, wherein the recess has a wedge shape including two side walls converging toward the conduit.

3. The guide shoe of claim 2, wherein each of the two side walls follows a straight line in the engagement surface of the guide shoe.

4. The guide shoe of claim 2, wherein each of the two side walls extends perpendicularly to the engagement surface of the guide shoe.

5. The guide shoe of claim 2, wherein each of the two side walls extends at an oblique angle to the engagement surface of the guide shoe.

6. (canceled)

7. The guide shoe of claim 1, wherein the engagement surface defines a flat plane around the recess.

8. The guide shoe of claim 1, further comprising a biasing device configured to exert a force biasing the engagement surface of the guide shoe into contact with the chain.

9. A chain drive mechanism comprising:
a chain extending around a drive sprocket and a driven sprocket for transmitting torque therebetween;
a snubber including a guide shoe having an engagement surface contacting a side of the chain between the drive sprocket and the driven sprocket, wherein the guide shoe is disposed inside of the chain, with the chain surrounding the guide shoe;
a conduit configured to convey lubricant fluid away from the engagement surface; and
the engagement surface of the guide shoe defining a recess with an opening therein, the recess being configured to convey lubricant fluid from the chain and through the conduit by motion of the chain along the engagement surface of the guide shoe.

10. The chain drive mechanism of claim 9, further comprising a biasing device configured to bias the engagement surface of the guide shoe into contact with the chain.

11. (canceled)

12. (canceled)

13. The chain drive mechanism of claim 9, wherein the guide shoe is one of two or more guide shoes each contacting the chain.

14. The chain drive mechanism of claim 13, wherein the two or more guide shoes are each disposed inside of the chain, with the chain surrounding the two or more guide shoes.

15. (canceled)

16. The chain drive mechanism of claim 9, wherein the recess in the engagement surface of the guide shoe includes a floor that slopes downwardly away from the engagement surface and toward the conduit.

17. The chain drive mechanism of claim 9, wherein the recess in the engagement surface of the guide shoe has a wedge shape including two side walls converging toward the conduit, and wherein each of the two side walls extends perpendicularly to the engagement surface of the guide shoe.

18. A guide shoe for a chain drive mechanism, said guide shoe comprising:
an engagement surface configured to contact a chain;
a conduit configured to convey lubricant fluid away from the engagement surface; and
the engagement surface of the guide shoe defining a recess, the recess configured to convey the lubricant fluid from the chain into the conduit by motion of the chain along the engagement surface of the guide shoe,
wherein the recess has a wedge shape including two side walls converging toward the conduit, and
wherein each of the two side walls extends perpendicularly to the engagement surface of the guide shoe.

19. The guide shoe of claim 18, wherein the recess includes a floor that slopes downwardly away from the engagement surface and toward the conduit.

20. The guide shoe of claim 18, wherein each of the two side walls follows a straight line in the engagement surface of the guide shoe.

21. The guide shoe of claim 18, wherein each of the two side walls extends at an oblique angle to the engagement surface of the guide shoe.

22. The guide shoe of claim 18, wherein the engagement surface defines a flat plane around the recess.

23. The guide shoe of claim 1, further comprising a biasing device configured to exert a force biasing the engagement surface of the guide shoe into contact with the chain.
